(19) United States
(12) Patent Application Publication
(10) Pub. No.: US 2013/0328390 A1
(43) Pub. Date: Dec. 12, 2013

(54) Capacitive transformer

(71) Applicant: John Kissane, Far Hills, NJ (US)

(72) Inventor: John Kissane, Far Hills, NJ (US)

(21) Appl. No.: 13/507,120

(22) Filed: Jun. 6, 2012

(51) Int. Cl. B60L 1/00

(52) U.S. Cl. 307/10.1

(57) ABSTRACT

My invention shows how to increase the duration of life of a battery used for an electric car. This is done by separating the circuit that contains the battery and the circuit that drives the motor of the electric car. Electricity is then induced in the latter circuit by a capacitor that has a coil of wire in it. When the capacitor is charged current is then induced in the coil of wire by inductance. This electricity then goes on to power the electric car.

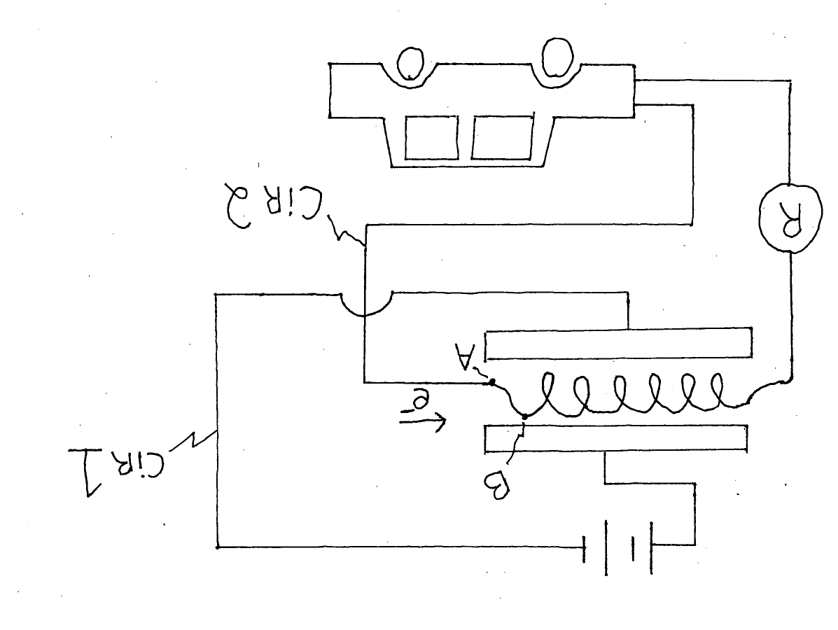

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING A TABLE, OR A COMPUTER PROGRAM LISTING COMPACT DISC APPENDIX

Not Applicable

### BACKGROUND OF THE INVENTION

For years people have been trying to invent an electric car that would have long range capabilities. Much of the effort has been on trying to develop bigger and bigger batteries. My invention takes a different approach. By using my battery technology an electric car would have long range capabilities because the only load that would be on the battery would be that of a capacitor. Furthermore the battery would last much longer.

### BRIEF SUMMARY OF THE INVENTION

The invention shows how to power an electric car indirectly by powering a capacitor with a coil of wire held in place by a foam dielectric and receiving inductance by said capacitor. The electricity induced in the coil of wire would then go on to power the electric car.

### BRIEF DESCRIPTION OF THE DRAWING

The Drawing shows two circuits, circuit 1 and 2. Circuit 1 is composed of a battery and a capacitor. Circuit 2 is composed of a coil of wire inside the said capacitor that goes to a rheostat and powers an electric car. The inductance generated by the capacitor in circuit 1 would generate Current in the coil of wire in circuit 2 indirectly. Also shown in the drawing are points A and B in circuit 2 as well as an arrow and an e-minus indicating the flow of electricity in circuit 2.

### DETAILED DESCRIPTION OF THE INVENTION

Referring more particularly to the drawing, there are two circuits shown (circuits 1&2). Circuit 1 is composed of a battery and a capacitor. Because the capacitor is the only load on the battery, the battery will last very long. Circuit 2 is composed of a coil of wire inside the capacitor held in place by a foam dielectric. When current is induced in the coil of wire it then goes to a rheostat which could be connected to the gas peddle of an electric car and then goes on to power the electric car.

Circuit 1 induces current in circuit 2 indirectly through inductance. When the battery is engaged the capacitor in circuit 1 begins to charge. When it is charged it induces electricity in circuit 2 at point A to be attracted to point B by the charged plates around it. This sets up current in the coil of wire in circuit 2. This current is then used to power an electric car which is controlled by a rheostat.

My invention shows how you can maximize the output of a battery that Powers an electric car thereby increasing the duration of time for which it could be used. Because the only load on the battery in my arrangement is that of a capacitor it is clear that it would last much longer then one connected to a motor of an electric car.

What I claim as my invention is:

1. Unique circuitry composed of two circuits that allows for current to be induced in a coil of wire by a capacitor that surrounds it that is charged by a battery, this current then goes on to power an electric car through a rheostat, because the only load on the battery is that of a capacitor its duration of life is much longer and is thereby maximized, this battery technology shows how to get the most out of a battery, and is done by indirectly inducing current in a coil of wire that is surrounded by a capacitor, this current then goes on to power an electric car, furthermore I claim that the use of this technology as applied to an electric car is new and unique.
